(19) United States
(12) Patent Application Publication
(10) Pub. No.: US 2016/0011377 A1
(43) Pub. Date: Jan. 14, 2016

(54) OPTICAL DEVICE

(71) Applicant: SUMITOMO OSAKA CEMENT CO., LTD., Chiyoda-ku, Tokyo (JP)

(72) Inventors: Miki OKAMURA, Chiyoda-ku, Tokyo (JP); Tokutaka HARA, Chiyoda-ku, Tokyo (JP)

(21) Appl. No.: 14/768,888

(22) PCT Filed: Feb. 19, 2014
(86) PCT No.: PCT/JP2014/053940

§ 371 Date: Aug. 19, 2015

(30) Foreign Application Priority Data
Feb. 21, 2013 (JP) 2013-032404

(51) Int. Cl. G02B 6/32; G02B 6/122

(52) U.S. Cl. CPC G02B 6/327; G02B 6/122; G02B 2006/12147

(57) ABSTRACT

An optical device, comprising: a waveguide substrate in which two waveguides are formed along a waveguide plane, and a first emission light beam and a second emission light beam which are emitted from the two waveguides in parallel with each other; and a condensing member including a first condensing element which emits the first emission light beam after collimation, and a second condensing element which emits the second emission light beam after collimation, the first condensing element and the second condensing element being formed in an element installation surface with a constant interval, wherein when an angle made by an emission end surface of the waveguide substrate in the waveguide plane and a waveguide direction that is an extension direction of the waveguide is set as θ, a relationship of 0°<|θ|<90° is satisfied.

### TECHNICAL FIELD

The present invention relates to an optical device.

### BACKGROUND ART

As an optical device capable of supporting high-capacity optical fiber communication as fast as 100 Gb/s, DP-QPSK (Dual Polarization-Quadrature Phase Shift Keying) is known. For example, in the DP-QPSK of Patent Literature No. 1, two sets of Mach-Zehnder type optical waveguides are provided on a LN substrate, and one or both polarization planes of light beams emitted from the respective Mach-Zehnder type optical waveguide are rotated to multiplex the light beams in a relationship in which the polarization planes of the light beams are perpendicular to each other. According to this, the light beams are polarization-combined, and the combined light beams are output. With regard to a configuration of a polarization-combining optical system, for example, Patent Literature No. 2 discloses the following configuration. After the light beams are collimated (condensed) with a lens (condensing element) that is disposed in the vicinity of an emission end surface of a substrate, the polarization plane of the light beams on one side is rotated with a half-wavelength plate, multiplexing is performed with a mirror and a polarization beam splitter (PBS), and multiplexed light beams are emitted. However, in this configuration, space or man-hours are necessary for the mounting and adjustment of individual optical systems, and thus there is a problem relating to the size of a modulator, or member and assembling cost. To solve the problem, as described in Patent Literature No. 3, for example, it can be considered to use a lens array (condensing member) in which lenses, to which light beams emitted from two optical paths are incident and from which the light beams are emitted in parallel, are arrayed and formed, as the condensing element that is mounted in the vicinity of the emission end of the substrate in Patent Literature No. 2. When using the lens array or a polarization-combining element in which the mirror or PBS are integrally formed, a reduction in the size of the modulator and the member cost, or an improvement in productivity is expected.

### CITATION LIST

### Patent Literature

[Patent Literature No. 1] Japanese Laid-open Patent Publication No. 2012-078508

[Patent Literature No. 2] Japanese Laid-open Patent Publication No. 2012-047953

[Patent Literature No. 3] Japanese Laid-open Patent Publication No. 2004-151416

### SUMMARY OF INVENTION

### Technical Problem

However, a manufacturing error which occurs due to a mold, a photo-mask, and the like, may be included in a waveguide distance of waveguides and a lens distance of a lens array in a modulator. Specifically, when assuming that an error of approximately 1 μm occurs in each member as the manufacturing error, and when considering the manufacturing errors in both members, a error of a maximum of approximately 2 μm may occur between both members. In this case, a deviation from a designed optical path and the like occurs due to such things as light beams emitted from the two waveguides not being parallel with each other, and thus coupling efficiency of an optical output port, which is configured to output the light beams from a modulator to an outer side, decreases. As a result, it can be considered that an amount of light beams which are emitted from the modulator may decrease.

The present invention has been made in consideration of the above-described circumstance, and an object thereof is to provide an optical device capable of appropriately maintaining an amount of light beams which are output to an outer side.

### Solution to Problem

According to an aspect of the invention, there is provided an optical device including: a waveguide substrate in which two waveguides are formed along a waveguide plane, and a first emission light beam and a second emission light beam are emitted from the two waveguides in parallel with each other from an emission end surface different from the waveguide plane; and a condensing member including a first condensing element to which the first emission light beam is incident and which emits the first emission light beam after collimation, and a second condensing element to which the second emission light beam is incident and which emits the second emission light beam after collimation, the first condensing element and the second condensing element being formed in an element installation surface with a constant interval. When an angle made by an emission end surface of the waveguide substrate in the waveguide plane and a waveguide direction that is an extension direction of the waveguide is set as θ, a relationship of 0°<|θ|<90° is satisfied.

According to the optical device, the angle θ made by the emission end surface of the optical waveguide substrate and the waveguide direction, is set to satisfy a relationship of 0°<|θ|<90°, and thus it is possible to allow positions of the emission ends from the waveguide substrates of the two waveguides to shift from each other along the waveguide direction. With regard to the deviation, it is possible to adjust a distance between the two waveguides and a distance between two lenses of the condensing member by adjusting a mounting position of the condensing member in which the first and second condensing elements are formed in the element installation surface. According to this, it is possible to appropriately maintain the amount of light beams which are output to an outer side.

Here, as a configuration capable of effectively exhibiting the operation, specifically, the angle θ, which is made by the emission end surface of the waveguide substrate and the waveguide direction, may be determined on the basis of a distance between the first emission light beam and the second emission light beam, and a distance between the first condensing element and the second condensing element.

In addition, when an angle made by the element installation surface and the waveguide direction is set as x, a relationship of θ=x may be satisfied.

In addition, when an angle made by the element installation surface and the waveguide direction is set as x, a relationship of θ≠x may be satisfied.

Here, the optical device may further include a medium having a refractive index different from a refractive index of the waveguide on an optical path of a light beam to be emitted from the first condensing element and an optical path of a light beam to be emitted from the second condensing element between the condensing member and the emission end surface of the waveguide substrate.

The element installation surface of the condensing member may be provided on a side opposite to an end surface to which the first emission light beam and the second emission light beam are incident, and an angle made by the end surface to which the first emission light beam and the second emission light beam are incident, and the waveguide direction, may be different from the angle x.

As described above, the element installation surface of the condensing member and the end surface on an incident side may not be parallel with each other, and may be set to have angles different from each other. When the shape of the condensing member is appropriately changed in accordance with the interval between the waveguides or the intervals between the lenses, it is possible to more appropriately realize an environment capable of appropriately maintaining the amount of light beams which are output to an outer side.

### Advantageous Effects of Invention

According to the aspect of the invention, it is possible to provide an optical device capable of appropriately maintaining an amount of light beams which are output to an outer side.

### BRIEF DESCRIPTION OF DRAWINGS

FIG. 1 is a view schematically illustrating a configuration of an optical modulator according to a first embodiment.

FIG. 2 is a view illustrating an arrangement of an optical waveguide and a condensing member in an optical modulator of the related art.

FIG. 3 is a view illustrating an arrangement of an optical waveguide and a condensing member in the optical modulator according to the first embodiment.

FIG. 4 is a view illustrating an arrangement of an optical waveguide and a condensing member in an optical modulator according to a second embodiment.

FIG. 5 is a view illustrating a variation in an optical path due to a medium that is used in the optical modulator according to the second embodiment.

FIG. 6 is a view illustrating a modification example of the arrangement of the optical waveguide and the condensing member in the optical modulator according to the second embodiment.

FIG. 7 is a view illustrating a modification example of the arrangement of the optical waveguide and the condensing member in the optical modulator according to the second embodiment.

FIG. 8 is a view illustrating an arrangement of an optical waveguide and a condensing member in the optical modulator according to a third embodiment.

### DESCRIPTION OF EMBODIMENTS

Hereinafter, an embodiment of the invention will be described in detail with the accompanying drawings.

### First Embodiment

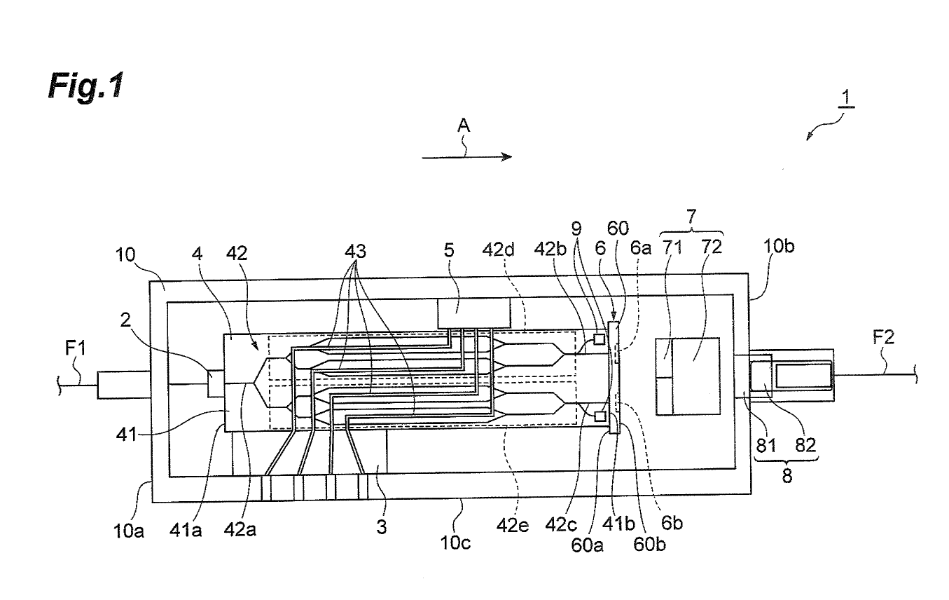

FIG. 1 is a view schematically illustrating a configuration of an optical modulator that is a kind of an optical device according to the first embodiment of the invention. As illustrated in FIG. 1, an optical modulator 1 is a device that modulates input light beams introduced by an optical fiber F1 and outputs modulated light beams to an optical fiber F2. The optical modulator 1 may include an optical input port 2, a relay part 3, a light modulating element 4, a termination end 5, a condensing member 6, a polarization-combining part 7, an optical output port 8, a monitoring part 9, and a case 10.

The case 10 is a box-shaped member that extends in one direction (hereinafter, referred to as “direction A”), and is made of, for example, stainless steel. The case 10 has one end surface 10a and the other end surface 10b which are both end surfaces in the direction A. A hole, into which the optical fiber F1 is inserted, is provided in the one end surface 10a. For example, the case 10 accommodates the optical input port 2, the relay part 3, the light modulating element 4, the termination end 5, the condensing member 6, the polarization-combining part 7, and the monitoring part 9.

The optical input port 2 supplies an input light beam introduced by the optical fiber F1 to the light modulating element 4. The optical input port 2 may include a sub-part that supports bonding between the optical fiber F1 and the light modulating element 4.

The relay part 3 relays a modulation signal that is an electrical signal supplied from an outer side, and outputs the modulation signal to the light modulating element 4. For example, the relay part 3 inputs the modulation signal through a modulation signal input connector provided on a side surface 10c of the case 10, and outputs the modulation signal to the light modulating element 4.

The light modulating element 4 is a device that converts input light beams supplied from the optical input port 2 into modulated light beams in accordance with the modulation signal output from the relay part 3. The light modulating element 4 may include a substrate 41 (a waveguide substrate), an optical waveguide 42, and a signal electrode 43. The substrate 41 is made of, for example, a dielectric material such as lithium niobate (LiNbO₃, hereinafter, referred to as “LN”) that exhibits an electro-optical effect. A light modulating element using the LN is referred to as a LN light modulating element. The substrate 41 extends along the direction A, and has one end 41a and the other end 41b which are both ends in the direction A. In addition, examples of the material that constitutes the substrate include a semiconductor, an EO polymer, and the like in addition to the dielectric material.

The optical waveguide 42 is provided on the substrate 41. For example, the optical waveguide 42 is a Mach-Zehnder (MZ) type optical waveguide, and has a structure in accordance with a modulation type of the light modulating element 4. In this example, the modulation type of the light modulating element 4 is a DP-QPSK (Dual Polarization-Quadrature Phase Shift Keying) modulation type. In this case, the optical waveguide 42 includes an input waveguide 42a, a Mach-Zehnder part 42d, a Mach-Zehnder part 42e, an output waveguide 42b, and an output waveguide 42c. The input waveguide 42a extends from the one end 41a of the substrate 41 along the direction A, is branched, and the branched parts are connected to an input end of the Mach-Zehnder part 42d and an input end of the Mach-Zehnder part 42e, respectively. The output waveguide 42b extends from an output end of the Mach-Zehnder part 42d to the other end 41b along the direction A. The output waveguide 42c extends from an output end of the Mach-Zehnder part 42e to the other end 41b along a surface (waveguide plane) including the direction A in the direction A. That is, the direction A corresponds to a waveguide direction that is an extension direction of the waveguide.

The signal electrode 43 is a member configured to apply an electrical field in accordance with the modulation signal to the optical waveguide 42, and is provided on the substrate 41. The arrangement and the number of a plurality of the signal electrodes 43 are determined in accordance with a direction of a crystal axis of the substrate 41 and a modulation type of the light modulating element 4. Modulation signals, which are output from the relay part 3, are applied to the signal electrodes 43, respectively.

In the light modulating element 4, input light beams, which are input from the optical input port 2 to the light modulating element 4, are guided to the Mach-Zehnder part 42d and the Mach-Zehnder part 42e by the input waveguide 42a. The input light beams are modulated in each of the Mach-Zehnder part 42d and the Mach-Zehnder part 42e, pass through the output waveguide 42b and the output waveguide 42c, and are output from the light modulating element 4.

The termination end 5 is an electrical termination of a modulation signal. The termination end 5 may be provided with a resistor corresponding to each of the signal electrodes 43 of the light modulating element 4. One end of each resistor is electrically connected to each of the signal electrodes 43 of the light modulating element 4, and the other end of the resistor is connected to a ground potential. A resistance value of the resistor is approximately the same as a characteristic impedance of the signal electrode 43, and is, for example, approximately 50 Ω.

The condensing member 6 condenses the modulated light beams output from the light modulating element 4. The condensing member 6 is provided on the other end 41b (emission end surface) of the substrate 41. The condensing member 6 includes a base material 60, and, for example, condensing elements 6a and 6b in the other end surface 60b that is opposite to one end surface 60a on the other end 41b side of the substrate 41. For example, the condensing elements 6a and 6b are condensing lenses. The base material 60 has an approximately rectangular parallelepiped shape, and has light transmitting properties similar to the condensing elements 6a and 6b. The one end surface 60a and the other end surface 60b of the base material 60 are parallel with each other. The condensing element 6a is provided to an output end of the output waveguide 42b. Light beams (first emission light beams), which are emitted from an end of the output waveguide 42b on the other end 41b side, are input to the condensing element 6a, and the condensing element 6a collimates the light beams and emits the collimated light beams. In addition, the condensing element 6b is provided to an output end of the output waveguide 42c. Light beams (second emission light beams), which are emitted from an end of the output waveguide 42c on the other end 41b side, are input to the condensing element 6b, and the condensing element. 6b collimates the light beams and emits the collimated light beams. As the condensing lens, a diffractive lens such as a Fresnel lens and a holographic lens, a gradient index lens, and the like can be used in addition to a general spherical lens.

The condensing member 6 having the above-described configuration is appropriately realized as a lens array that is molded on the other end surface 60b (element installation surface) of the base material 60 in a state in which the condensing element 6a (first condensing element) and the condensing element 6b (second condensing element) are maintained with a constant interval. The condensing member 6 may be manufactured by bonding the condensing elements 6a and 6b, which are independently prepared, onto the surface of the base material 60. However, when the condensing member 6 is formed as a lens array on the surface or at the inside of the base material 60 by using a photo-process or a mold molding technology, a lens interval and performance become stable, and thus this case is more appropriate. In the following embodiment, description will be given of a case where the condensing member 6 is configured as a lens array in which the condensing element 6a and the condensing element 6b are mounted on the base material 60. Light beams condensed by the condensing member 6 are supplied to the polarization-combining part 7.

The polarization-combining part 7 combines plural modulated light beams output from the light modulating element 4. The polarization-combining part 7 may include a polarization rotary part 71 and a polarization-combining element 72. The polarization rotary part 71 may include a polarization rotary element and a dummy element. The polarization rotary element is an element that rotates a polarization direction of incident light beams, and examples thereof include a wavelength plate. The dummy element is an element that transmits the incident light beams without rotating the polarization direction of the incident light beams. The polarization rotary part 71 rotates a polarization direction of either the modulated light beam output from the output waveguide 42b of the light modulating element 4 or the modulated light beam output from the output waveguide 42c of the light modulating element 4, for example, by 90°, and does not rotate the other polarization direction. In addition, as another example, the polarization rotary part 71 may rotate the polarization direction of one modulated light beam by 45°, and may rotate the polarization direction of the other modulated light beam by −45°.

The polarization-combining element 72 is an element that changes an optical path in accordance with the polarization direction of the incident light beams, and is configured by, for example, a birefringent crystal such as rutile and YVO₄. The polarization-combining element 72 combines a light beam that is polarization-rotated by the polarization rotary part 71 and a light beam that is transmitted therethrough without being polarization-rotated by the polarization rotary part 71. In addition, the polarization-combining element 72 may be a polarization beam splitter (PBS). In addition, in the case of using the birefringent crystal, it is possible to employ a configuration in which polarization is rotated by 45° and −45° in order for the polarizations of two incident light beams to be perpendicular to each other.

The optical output port 8 outputs light beams combined by the polarization-combining part 7 to the optical fiber F2. The optical output port 8 may be provided with a window part 81 and a condensing element 82. The window part 81 is inserted into a hole provided in the other end surface 10b of the case 10. For example, the window part 81 is made of glass, and transmits the light beams combined by the polarization-combining part 7 to an outer side of the case 10. The condensing element 82 is provided on the outer side of the case 10. For example, the condensing element 82 is a condensing lens. The light beams, which are transmitted through the window part 81, are focused by the condensing element 82, and are output to the optical fiber F2.

The monitoring part 9 monitors, for example, complementary optical intensity in an optical output of the respective Mach-Zehnder parts 42d and 42e. The monitoring part 9 may be provided with a photoelectric conversion element. The photoelectric conversion element is an element configured to convert an optical signal into an electrical signal, and examples thereof include a photodiode. For example, on the substrate 41, the photoelectric conversion element is placed on a waveguide branched from the output waveguide 42b of the Mach-Zehnder part 42d, and receives an evanescent wave leaked from the waveguide, and outputs an electrical signal in accordance with the optical intensity thereof to a bias control unit (not illustrated). In addition, the monitoring part 9 may monitor the optical intensity of radiated light beams which are output from the light modulating element 4.

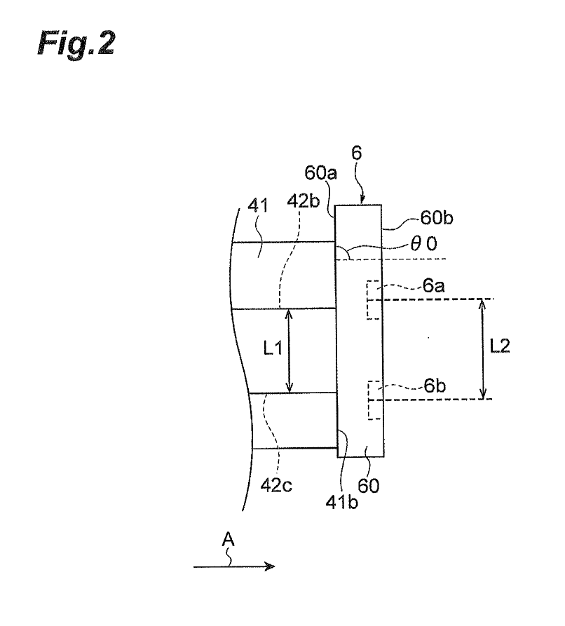

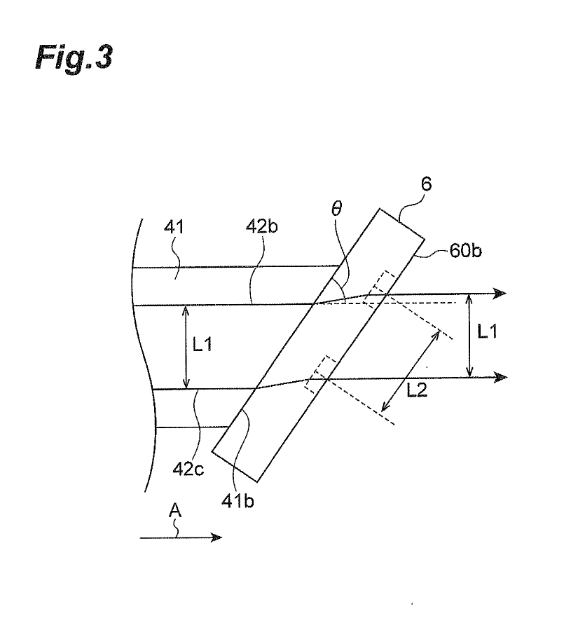

Here, description will be given of the shape of the other end 41b (emission end surface) of the substrate 41 and the condensing member 6, which are characteristic portions of the invention, with reference to FIG. 2 and FIG. 3. FIG. 2 is a view illustrating the arrangement of the other end 41b of a substrate 41 and a condensing member 6 in a typical modulator of the related art.

As illustrated in FIG. 2, at the other end 41b of the substrate 41 in an optical modulator 1′ of the related art, an emission end surface that forms the other end 41b is provided in such a manner that an angle θ0 made with a direction A becomes 90°, and thus light beams from output waveguides 42b and 42c are emitted from the other end 41b toward the direction A. When one end surface 60a of a base material 60, which constitutes the condensing member 6, is mounted to come into contact with the other end 41b, light beams emitted from the output waveguides 42b and 42c pass through the base material 60 and the condensing elements 6a and 6b, and are emitted from the condensing elements 6a and 6b. Here, when a distance between the two output waveguides 42b and 42c is set as L1, and a distance between the two condensing elements 6a and 6b is set as L2, in a case where a relationship of L1=L2 is satisfied, light beams emitted from the condensing elements 6a and 6b become parallel with each other. However, in a case where L1 and L2 satisfy a relationship of L1<L2 or L1>L2, at least a part of the light beams emitted from the output waveguides 42b and 42c is incident to the condensing element at a position different from the optical axis of the condensing elements 6a and 6b. When a light beam, which is incident to the condensing element at a position different from the optical axis of the condensing element, is emitted from the condensing element, an emission direction of the light beam is different from an incident direction (direction A). According to this, optical paths of the two light beams, which are emitted from the condensing elements 6a and 6b, are not parallel with each other, and as a result, condensing efficiency of the light beams at the optical output port 8 may decrease.

In contrast, in the optical modulator 1 according to this embodiment as described in FIG. 3, the other end 41b of the substrate 41 is inclined with respect to the direction A so that an angle θ made by the other end 41b (emission end surface) of the substrate 41 and the direction A satisfies a relationship of 0°<|θ|<90°. In addition, the condensing member 6 is mounted on the other end 41b of the substrate 41 in such a manner that the other end surface 60b (element installation surface) in which the condensing elements 6a and 6b of the condensing member 6 are provided, and the other end 41b of the substrate 41 are parallel with each other. According to this, an angle x made by the other end surface 60b in which the condensing elements 6a and 6b are provided, and the direction A satisfies a relationship of θ=x, and a relationship of 0°<|x|<90°. However, in a case where the refractive index of the condensing elements is less than the refractive index of the substrate, a total reflection angle is. For example, in a case of using a condensing element having a refractive index of 1.5 and a LiNbO₃ substrate having a refractive index of 2.2, the total reflection angle becomes θ=47°, and thus it is preferable that θ is 47° or more. In addition, it is preferable that 0 is an angle capable of sufficiently cutting a return light beam to the substrate. For example, in the case of using LiNbO₃ in the substrate, when the angle is 87° or less, it is possible to sufficiently cut a reflected return light beam.

At this time, the angle θ made by the emission end surface of the substrate 41 and the direction A (and angle x made by the other end surface 60b of the condensing member 6 and the direction A) is set to satisfy a relationship of L2 sin θ=L1(L2 sin x=L1) (provided that, L1<L2).

According to this, in a case where the interval L1 between the two output waveguides 42b and 42c, and the interval L2 between the condensing elements 6a and 6b are different from each other, the angle θ parallel with the angle x is set on the basis of the relationship, and thus it is possible to appropriately arrange the condensing element 6a and 6b with respect to the output waveguides 42b and 42c. Specifically, for example, in a case where design values in the optical modulator 1 are set to satisfy a relationship of L1=L2=500 μm, there is a possibility that the interval L1 between the waveguides may be 499 μm, and the interval L2 between the centers of the condensing elements may be 501 μm due to a manufacturing error and the like. In this case, the condensing member 6 is fixed to the substrate 41 in a state in which the other end 41b (emission end surface) is inclined to satisfy a relationship of L2 sin θ=L1 and a relationship of θ=x=84.9° so as to prepare the optical modulator 1, thereby reducing a difference of the interval L2 between the condensing elements with respect to the interval L1 between the optical waveguides as much as possible. According to this, it is possible to suppress a situation in which the optical paths of the two light beams emitted from the condensing elements 6a and 6b are not parallel with each other due to the difference between L1 and L2, and the condensing efficiency decreases in the optical output port 8.

As described above, in the optical modulator 1 according to this embodiment, the angle θ, which is made by the other end 41b (emission end surface) of the waveguide substrate 41 and the direction A that is a propagation direction of a light beam emitted from the waveguide, is set to satisfy a relationship of 0°<|θ|<90°, and thus it is possible to allow positions of emission ends of the two output waveguides 42b and 42c to shift along the direction A. With regard to the shift, it is possible to adjust a distance between the two output waveguides 42b and 42c and a distance between the condensing elements 6a and 6b of the condensing member 6 by adjusting a mounting position of the condensing member 6 in which the condensing elements 6a and 6b are formed in the other end surface 60b. According to this, it is possible to appropriately maintain the amount of light beams which are output to an outer side.

In addition, in the optical modulator 1 of this embodiment, the condensing member 6 is inclined with respect to the direction A in such a manner that the angle θ made by the other end 41b (emission end surface) of the substrate 41 and the direction A satisfies a relationship of 0°<|θ|<90°, and the angle x, which is made by the other end surface 60b in which the condensing elements 6a and 6b of the condensing member 6 are provided, and the direction A, satisfies a relationship of 0=x. According to this, it is easy to determine the angle x on the basis of a difference between the distance between the two output waveguides 42b and 42c, and the distance between the condensing elements 6a and 6b of the condensing member 6, and thus it is possible to appropriately maintain the amount of light beams, which are output to an outer side, through simple adjustment with respect to respective members of the optical modulator 1.

### Second Embodiment

Next, an optical modulator according to a second embodiment will be described. In the optical modulators in the second embodiment and the subsequent embodiments, description will be given of a case where the angle θ made by the other end 41b (emission end surface) of the substrate 41 and the direction A, and the angle x made by the other end surface 60b in which the condensing elements 6a and 6b of the condensing member 6 are provided and the direction A are different from each other.

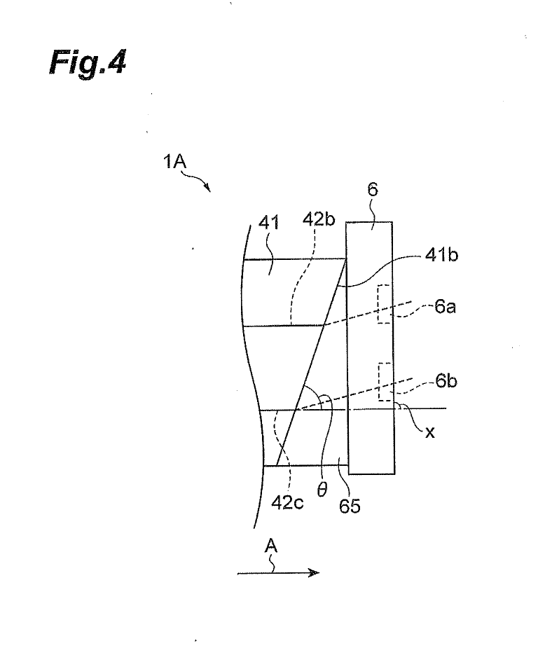

FIG. 4 is a view enlarging the vicinity of the other end 41b (emission end surface) of the substrate 41 and the condensing member 6 in an optical modulator 1A according to the second embodiment. The optical modulator 1A of this embodiment is different from the optical modulator of the first embodiment in that the angle θ made by the other end 41b of the substrate 41 and the direction A, and the angle x made by the one end surface 60a of the condensing member 6 and the direction A are different from each other. In the optical modulator 1A in FIG. 4, the one end surface 60a of the condensing member 6 is inclined with respect to the other end 41b of the substrate 41, and θ is not equal to x. In addition, description will be given of a case where a gap between the other end 41b of the substrate 41 and the one end surface 60a of the condensing member 6 is filled with an adhesive 65, which fixes the substrate 41 and the condensing member 6 to each other, as a medium having a refractive index different from that of the substrate 41. In addition, examples of the medium, which is inserted between the substrate 41 and the condensing member 6, include air, an optical adhesive, a glass wedge plate, and the like, and there is no particular limitation to the medium as long as the medium transmits light beams. In addition, it is preferable that the refractive index of the medium is approximately the same as that of the condensing member so as to prevent a reflection of the light beams at an interface between the medium and the condensing member. Alternatively, an antireflective film may be appropriately provided on the interface between the medium and the condensing member.

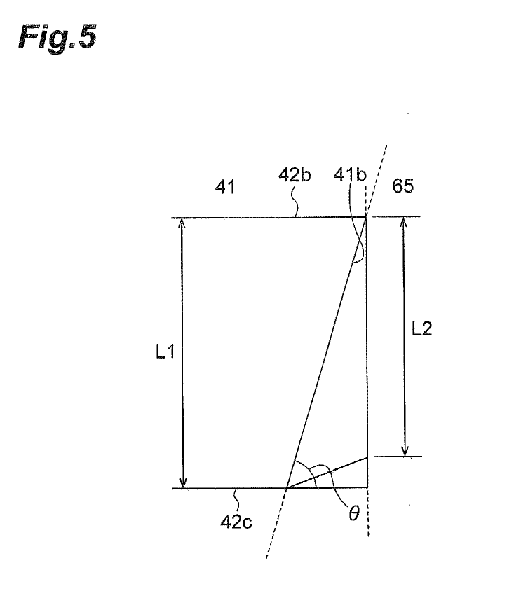

Description will be given of a method of aligning the position of the condensing elements 6a and 6b of the condensing member 6 with respect to the two output waveguides 42b and 42c in a state in which the medium is inserted between the substrate 41 and the condensing member 6 with reference to a schematic view of FIG. 5. Here, for simplicity, it is assumed that the one end surface 60a (and the other end surface 60b) of the condensing member 6 is perpendicular to the direction A (x=90°), and the angle made by the other end 41b of the substrate 41 and the one end surface 60a of the condensing member 6 is set to 90°−θ (π/2−θ). Under these conditions, when an interval of the two output waveguides 42b and 42c is set as L1, an interval between the condensing elements 6a and 6b is set as L2, the refractive index of the substrate 41 is set as n1, and the refractive index of the medium (adhesive 65) is set as n2, the following relationship is established.

L2=L1(1−1/tan θ·[tan {θ−cos−1(n1/n2×cos θ)}])

Accordingly, for example, when L1 is 500 μm, n1 is 2.2, n2 is 1.5, and θ is 85°, L2 becomes 498 μm. In addition, when the refractive index n2 of the medium is changed, L2 varies in accordance with the change. Accordingly, it is possible to change the relationship between L1 and L2 through selection of the medium having a refractive index different from that of the substrate without changing the angle (90°−θ) made by the other end 41b of the substrate 41 and the one end surface 60a of the condensing member 6. Through the change in the relationship, it is possible to align the position of the condensing elements 6a and 6b of the condensing member 6 with respect to the two output waveguides 42b and 42c. In addition, the first embodiment corresponds to a case of L1<L2, but this embodiment can also correspond to a case of L1>L2.

Even in a case where, as is the case with the optical modulator 1A illustrated in the second embodiment, the other end 41b (emission end surface) of the substrate 41 is inclined with respect to the direction A in such a manner that the angle θ made by the other end 41b and the direction A satisfies a relationship of 0°<|θ|<90°, and the angle x made by the other end surface 60b in which the condensing elements 6a and 6b of the condensing member 6 are provided and the direction A satisfies a relationship of θ≠x, it is possible to appropriately maintain the amount of light beams which are output to an outer side of the optical modulator 1A.

In addition, in a case of the configuration in which the medium having a refractive index different from that of the substrate 41 is inserted between the substrate 41 and the condensing member 6, it is possible to align the position of the condensing elements 6a and 6b of the condensing member 6 with respect to the two output waveguides 42b and 42c by changing the relationship between the interval L1 between the two output waveguides 42b and 42c and the interval L2 between the condensing elements 6a and 6b in accordance with the refractive index of the medium, and thus it is possible to maintain the amount of light beams which are output to an outer side of the optical modulator 1A in a more appropriate manner.

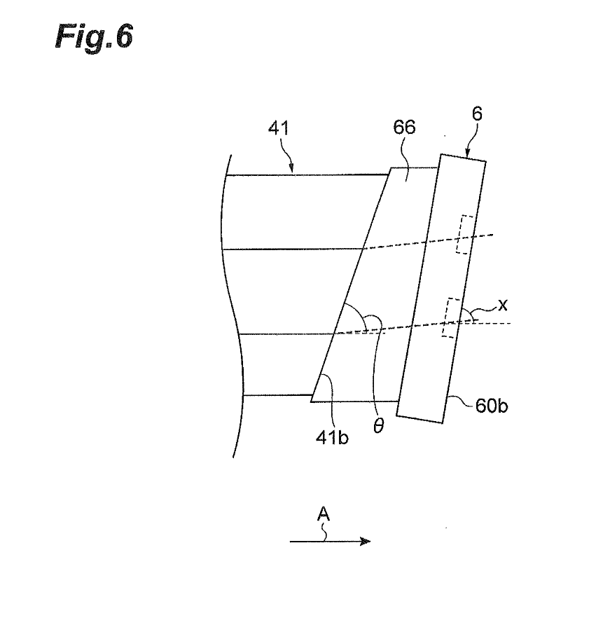

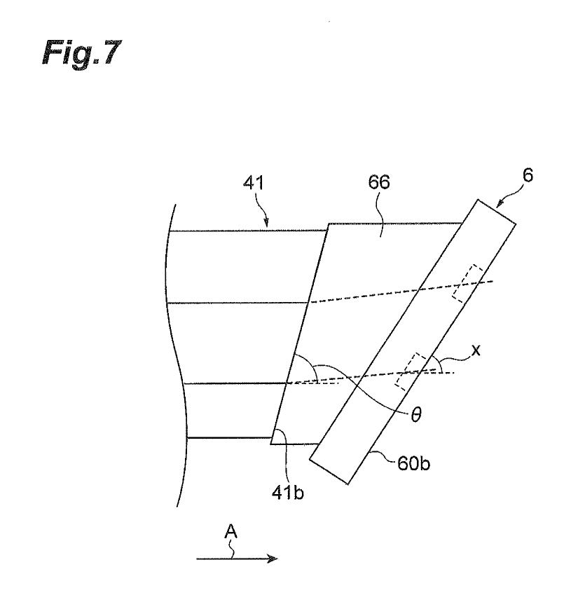

In addition, a modification example of the optical modulator 1A according to the second embodiment is illustrated in FIG. 6 and FIG. 7. In the optical modulator 1A illustrated in FIG. 3 and FIG. 4, description has been given of the case where the one end surface 60a and the other end surface 60b of the condensing member 6 are perpendicular to the direction A. However, if the one end surface 60a and the other end surface 60b of the base material 60 are parallel with each other, a configuration, in which the angle x made by the main surface of the condensing member 6 and the direction A satisfies a relationship of 0°<|θ|<90°, is also possible.

FIG. 6 schematically illustrates a case where the angle x made by the main surface of the base material 60 and the direction A is larger than the angle θ made by the other end 41b of the substrate 41 and the direction A (θ<x). In addition, FIG. 7 schematically illustrates a case where the angle x made by the main surface of the base material 60 and the direction A is smaller than the angle θ made by the other end 41b of the substrate 41 and the direction A (θ>x). In addition, FIG. 6 and FIG. 7 illustrate a configuration in which a glass wedge plate 66 is inserted as the medium. In the case of using the glass wedge plate 66 as the medium between the substrate 41 and the condensing member 6, it is easy to appropriately fix the substrate 41 and the condensing member 6 at a desired angle by using, for example, a fixing jig, and the like.

As illustrated in FIG. 5 to FIG. 7, it is possible to make the angle θ made by the other end 41b of the substrate 41 and the direction A, and the angle x made by the main surface of the base material 60 and the direction A different from each other, and it is possible to appropriately change the angle θ and the angle x. The angle θ and the angle x are preferably determined on the basis of the interval L1 between the two output waveguides 42b and 42c, the interval 12 between the condensing elements 6a and 6b, a difference between the refractive index of the substrate 41 and the refractive index of the medium, and the like.

### Third Embodiment

Next, an optical modulator of a third embodiment will be described. Optical modulators in the third embodiment and the subsequent embodiments are different from the optical modulators in the first embodiment and the second embodiment in the shape of the condensing elements 6a and 6b.

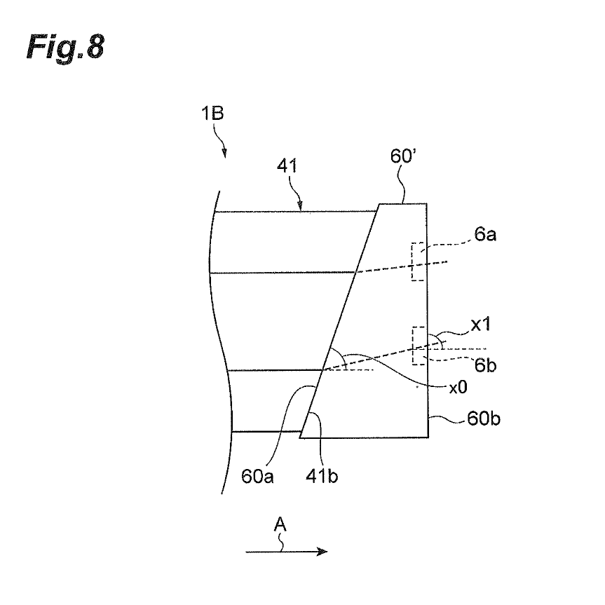

FIG. 8 is a view enlarging the vicinity of the other end 41b (emission end surface) of the substrate 41 and the condensing member 6 in an optical modulator 1B according to the third embodiment. In the optical modulator 1B according to this embodiment, an angle x0 made by one end surface 60a of the condensing member 6 and the direction A, and an angle x1 made by the other end surface 60b in which the condensing elements 6a and 6b are provided and the direction A are different from each other (x0≠x1). That is, a base material 60′ of the condensing member 6 is molded in a wedge shape, and the one end surface 60a is connected to the substrate 41. On the other hand, the condensing elements 6a and 6b are provided in the other end surface 60b.

In a case of using the condensing member 6 having the configuration as described above, the base material 60 of the condensing member 6 has the function of the medium, which is provided between the substrate 41 and the condensing member 6, similar to the optical modulator 1A of the second embodiment, and thus it is possible to appropriately set the position of the condensing elements 6a and 6b of the condensing member 6 with respect to the two output waveguides 42b and 42c. In addition, the medium may not be provided between the substrate 41 and the condensing member 6, and thus it is also possible to reduce the number of parts.

In addition, it is preferable to determine the angle x0 made by the one end surface 60a of the condensing member 6 and the direction A, and the angle x1 made by the other end surface 60b in which the condensing elements 6a and 6b are provided and the direction A on the basis of the interval L1 between the two output waveguides 42b and 42c, the interval L2 between the condensing elements 6a and 6b, a difference between the refractive index of the substrate 41 and the refractive index of the base material 60 of the condensing member 6, and the like.

Hereinbefore, the optical modulators according to the embodiments have been described, but the optical device of the invention is not limited to the embodiments. For example, in the embodiment, description has been given of the optical modulators of the DP-QPSK modulation type. However, the configuration of the invention is applicable to an optical device including a substrate in which two output waveguides are formed, and which emits the first emission light beams and the second emission light beams in parallel with each other from the substrate, and a condensing part provided with two condensing elements which individually collimate the first emission light beams and the second emission light beams and emits the collimated light beams. In addition, in the description, the condensing elements 6a and 6b are provided in the surface of the base material 60, and the end surface 60b is set as an element installation surface. However, in a case where the positions of the condensing element 6a and 6b are not located at an equal distance from the surface of the base material 60, a plane, which includes a straight line connecting the condensing elements 6a and 6b and is perpendicular to a plane including the output waveguides 42b and 42c, may be considered as the element installation surface. Here, for example, the straight line connecting the condensing elements 6a and 6b is a straight line that passes through an intersection between a principal plane of the condensing element 6a and a main light beam of the first emission light beams, and an intersection between a principal plane of the condensing element 6b and a main light beam of the second emission light beams. Accordingly, the element installation surface is not limited to 60b described in the examples, and is a concept that is used for illustration of a fixed positional relationship (interval) between the two condensing element. In an arbitrary configuration, if collimation can be effectively performed by adjusting the condensing member 6 in which the positional relationship of the two condensing elements is fixed, and a positional relationship (interval) between the first emission light beams and the second emission light beams, it should be understood that this configuration is included in the configuration of the invention.

In addition, description has been given of the configuration of the optical modulators according to the first to third embodiments, but the configurations described in the respective embodiments may be combined with each other. For example, the shape of the base material 61 of the condensing member 6 may be set to a wedge shape, and the medium may be provided between the condensing member 6 and the substrate 41.

In addition, in a case of mass production of the optical device according to the invention, the optical device can be produced substantially without deviation in a waveguide interval and a lens interval in the lens array in the same lot. Accordingly, after measurement of the waveguide interval and the lens interval in a member that is manufactured, when the angle θ of the other end 41b of the substrate 41, the angle x of the end surface 60b of the condensing member 6, the shape of the condensing member 6, and the like are determined once on the basis of the measurement result, it is also possible to perform manufacturing with the same setting in the lot, and it is possible to effectively manufacture a stable product with high precision.

### REFERENCE SIGNS LIST

1, 1A, 1B: Optical modulator
2: Optical input port
3: Relay part
4: Light modulating element
5: Termination end
6: Condensing member
6a, 6b: Condensing element
7: Polarization-combining part
8: Optical output port
9: Monitoring part
10: Case
41: Substrate
42b, 42c: Output waveguide
60: Base material

1. An optical device, comprising:
a waveguide substrate in which two waveguides are formed along a waveguide plane, and a first emission light beam and a second emission light beam are emitted from the two waveguides in parallel with each other from an emission end surface different from the waveguide plane; and
a condensing member including a first condensing element to which the first emission light beam is incident and which emits the first emission light beam after collimation, and a second condensing element to which the second emission light beam is incident and which emits the second emission light beam after collimation, the first condensing element and the second condensing element being formed in an element installation surface with a constant interval,
wherein when an angle made by an emission end surface of the waveguide substrate in the waveguide plane and a waveguide direction that is an extension direction of the waveguide is set as θ, a relationship of 0°<|θ|<90° is satisfied.

2. The optical device according to claim 1,
wherein the angle θ made by the emission end surface of the waveguide substrate and the waveguide direction, is determined on the basis of a distance between the first emission light beam and the second emission light beam, and a distance between the first condensing element and the second condensing element.

3. The optical device according to claim 1,
wherein when an angle made by the element installation surface and the waveguide direction is set as x, a relationship of θ=x is satisfied.

4. The optical device according to claim 1,
wherein when an angle made by the element installation surface and the waveguide direction is set as x, a relationship of θ≠x is satisfied.

5. The optical device according to claim 4, further comprising:
a medium having a refractive index different from a refractive index of the waveguide on an optical path of a light beam to be emitted from the first condensing element and an optical path of a light beam to be emitted from the second condensing element between the condensing member and the emission end surface of the waveguide substrate.

6. The optical device according to claim 4,
wherein the element installation surface of the condensing member is provided on a side opposite to an end surface to which the first emission light beam and the second emission light beam are incident, and
an angle made by the end surface to which the first emission light beam and the second emission light beam are incident, and the waveguide direction, is different from the angle x.
